(19) United States
(12) Patent Application Publication
(10) Pub. No.: US 2024/0076505 A1
(43) Pub. Date: Mar. 7, 2024

(54) Thermal Marine Coating System

(71) Applicant: Noel William Stewart, Jackson, CA (US)

(72) Inventor: Noel William Stewart, Jackson, CA (US)

(21) Appl. No.: 17/866,019

(22) Filed: Jul. 15, 2022

Related U.S. Application Data
(60) Provisional application No. 63/222,879, filed on Jul. 16, 2021.

(51) Int. Cl. C09D 5/16; C09D 5/10; C09D 7/61; C09D 7/63; C09D 105/00

(52) U.S. Cl. CPC C09D 5/1656; C09D 5/10; C09D 5/1625; C09D 7/61; C09D 7/63; C09D 105/00

(57) ABSTRACT

Thermal Marine Coating System is a bio-inhibitor for a water immersive surface including and not limited to a ship hull, off-shore windmill, buoy, and/or any other aquatic object. The bio-inhibiting action repels micro and macro organisms thereby preventing attachment to a vessel or other aquatic object immersed in seawater and/or freshwater. The coating matrix comprises waxes and a metallic soap very slowly and continuously agitated at constant temperature from blending of ingredients through application onto prepared substrate. The integrity of the matrix is non-porous and long lasting.

A claim of benefit is made for Provisional Application Number Ser. No. 63/222,879 dated 16 Jul. 2021.

This invention relates to aquatic objects such as ship hull paints and more particularly to a coating of this type which maintains its bio-inhibiting and anti-corrosive properties over unusually long time periods.

### BACKGROUND

For many years use has been made of anti-fouling paints on ship hulls and other surfaces exposed to sea wash. However, the effectiveness of these paints has usually been short so that ships were limited to cruise periods of a year or less before marine organisms, which include barnacles, annelids, mollusks, hydroids, tunicates, and algae, had reduced cruising speeds to pronouncedly low values. Moreover, these former paints have been found to posses in many cases certain deficiencies such as long drying times on initial application, inclusion of imported or rare elements, sagging tendency on fresh application or under high temperatures, and poor shock and crack resistance time.

The presently described bio-inhibiting coating has been found to overcome the above mentioned disadvantages and to show a definite improvement in effective life. Briefly stated the invention is a composition which includes, with nickel, gum resin and was, an appreciable percentage of metallic soaps of fatty acids or of naphthenic acid as a plasticizer for the gum resin, a control agent for the bio-inhibitor and an efficient sag control component.

Among the objects of the invention are to provide a composition having increased life in use, having no sagging tendencies under high temperature conditions, having resistance to shock and no temperature shrinking, and possessing strong base adhesion after substrate is coated with a thermal epoxy base. Further objects are to secure a coating which dried rapidly on application, has low viscosity to facilitate spray application, has good stability when held under heated conditions prior to, and during, application, is self-leveling to about 32 mils thickness, is relatively impermeable and non-absorptive in seawater and freshwater, and is strongly erosion resistant.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 is a bar chart illustrating the components of the Thermal Marine Coating System matrix in accordance with various embodiments.

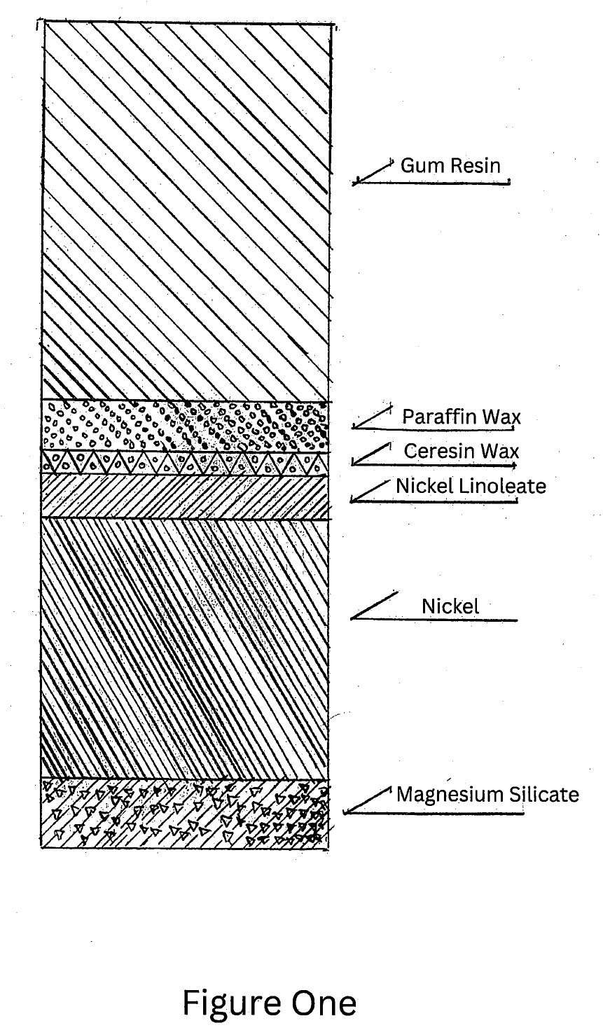

FIG. 2 is a diagram illustrating the system for the rotating thermal system apparatus mixing and agitating the matrix at a constant temperature in accordance with various embodiments.

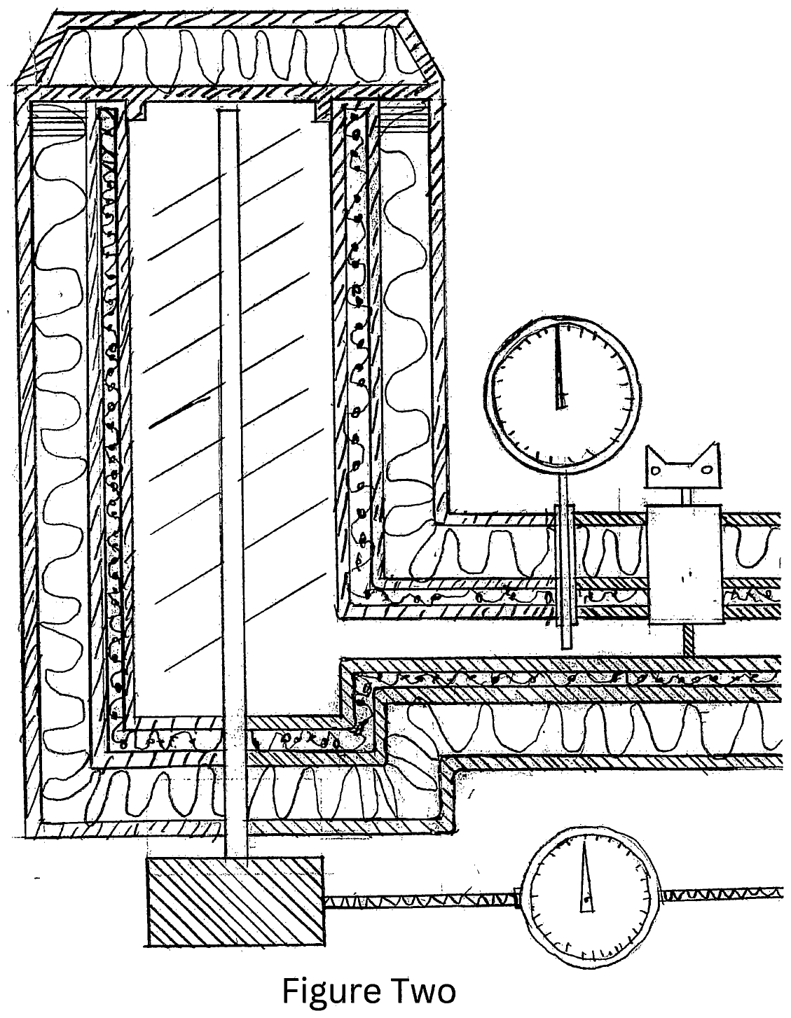

FIG. 3 is a diagram of the controller illustrating a method for moving the matrix at the same rate of rotation at constant temperature set by the left-most bottom gauge in accordance with various embodiments.

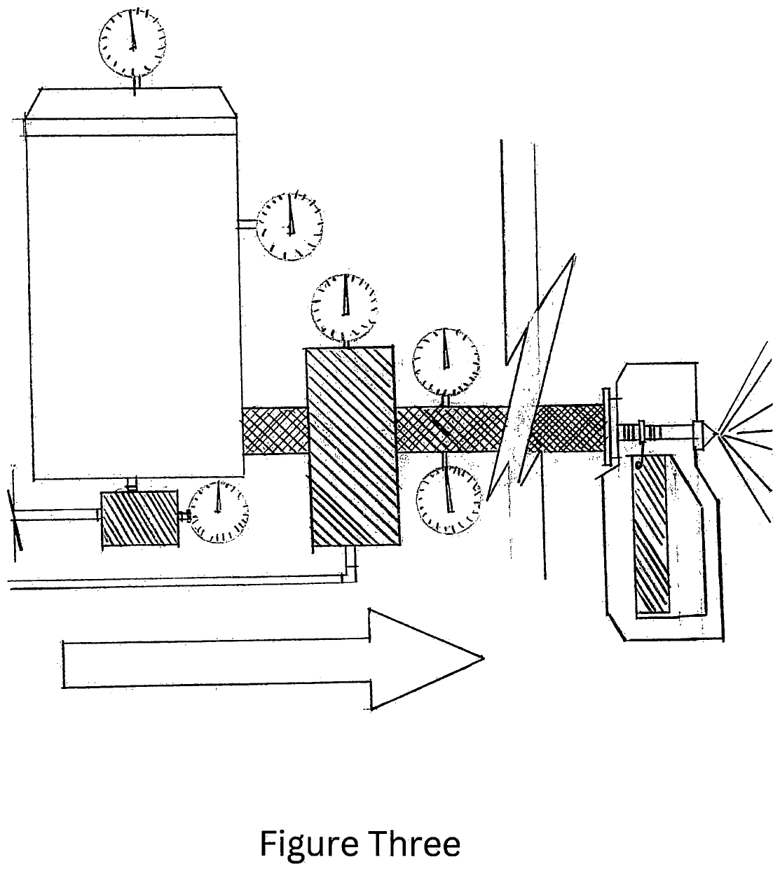

FIG. 4 is a diagram illustrating the application of the Thermal Marine Coating System matrix maintained at 250° F. on to substrate prepared prior to application with a thermal epoxy base layer to result in a uniform surface coating to the substrate in accordance with various embodiments.

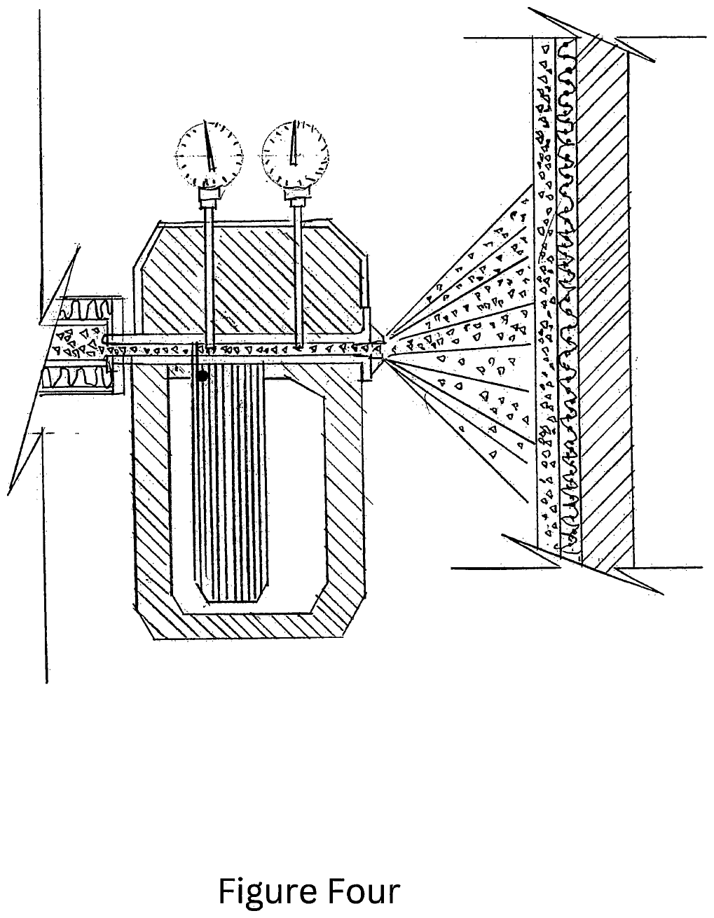

While the above-identified drawings set forth present disclosure, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the present disclosure.

### DESCRIPTION OF THE INVENTION

Other objects of the invention as well as attendant advantages and uses thereof, will become apparent on consideration of the following detailed description of the specific composition together with the process of making the coating.

The composition and percentages of ingredients therein follow:

| | Range | Preferred |
|---|---|---|
| | Percentages | Percentages |
| Gum resin | 36.67 to 41.67 | 41.67 |
| Paraffin wax | 4.44 to 8.00 | 4.44 |
| Ceresin wax | 2.38 to 4.55 | 2.38 |
| Nickel linoleate | 13.46 to 24.0 | 13.64 |
| Nickel | 32.46 to 37.87 | 32.46 |
| Magnesium silicate | 0 to 5.41 | 5.41 |

All the mentioned ingredients of the composition are necessary in this type of formula. The primary function of the waxes is to reduce the viscosity of the composition to a suitable spraying consistency when heated in the range from 260 to 300° F. The paraffin also functions as a plasticizer for the gum resin. The ceresin wax (melting point 173-175° F.) increases the sag resistance properties of the applied composition, i.e. it helps prevent the sagging or flowing of the applied coating when high temperature conditions prevail or when subjected to direct sunlight. The purpose of the metallic soap is to improve the physical properties of the coating and promote adhesion under water immersion conditions. The gum resin functions as the main resinous binder ingredient of the matrix. The nickel functions as the bio-inhibitor for the coating. The nickel remains within the non-porous coating. The magnesium silicate improves the bio-inhibiting action of the composition. If the ceresin wax were eliminated from the composition, the coating would have deficient sag resistance properties. If paraffin were eliminated, the composition would have too high a viscosity upon application.

In preparing the composition the waxes and gum resin are placed in a thermal electrical rotation component and heated to approximately 260° F. until the ingredients are blended. The matrix is then added. This matrix gives preference to nickel linoleate. The mixture of heated waxes, gum resin and soap is rotated very slowly and continuously by mechanical means while the temperature is slowly increased to a value of around 300° F. for a time period of at least 15 minutes after all the ingredients are in the thermal electrical rotation component so as to insure adequate dispersion. The finished product is then drained off into brick-like forms and allowed to cool and solidify; after which the bricks are put into the thermal rotation machine to liquefy thus keeping the integrity of the matrix uniform and complete.

The brick form is essential to the complete uniformity of the coating thus permitting the user to define the volume needed. In use the bricks are melted in the thermal rotation component to a temperature range of 250°-350° F. At this temperature the composition has a low viscosity and may therefore be applied to the prepared substrate surface for water immersion. The aquatic object should have received, prior to bio-inhibiting coating application onto the substrate, a coating of a thermal epoxy base, the bio-inhibiting coating then applied over the thermal epoxy base layer. The coating spreads readily to a smooth layer of about 32 mils thickness which is about five to ten times the thickness of the usual anti-fouling paint film.

The properties of the melted coating are such that it maintains good stability while being maintained in a molten state. On application to the vessel's or aquatic object's surface it dries rapidly with a total absence of sagging. In fact, its non-sagging property is an outstanding characteristic of this coating, it being unaffected by temperatures as high as 140° F. maintained for 24 hours and as high as 162° F. for short time intervals. Moreover, only a single coat is necessary, the coating smoothing down to a uniform layer approximately 30 mils thick. Tests have indicated that the coating has a penetration at 70° F. of 84.6 (A.S.T.M. Standard), a viscosity range between 260° F. and 300° F. of 35 to 70 centipoises respectively. No embrittlement of coating or settling of pigments after 8 hours of heating at 300° F., capacity for application as low as 270° F., complete adhesion after 90 degrees base bending at 77° F., over ½ inch rod, resistance to shock in temperature range 35° F. to 77° F., crack resistant at Dry Ice temperature, and normal adhesion of 22.5 lbs. per square inch.

The overall usefulness of the coating as a bio-inhibiting medium is apparent from the fact that the bio-inhibiting action thereof is maintained as shown by actual test for time periods of over three years with the coating still effective at the end of this period. This is a performance markedly superior to paints now commonly used for prevention of growth of marine organisms on aquatic surfaces.

The following reference is of record in the file of this patent:

### United States Patents

| Number | Name | Date |
|---|---|---|
| 2,602,752 | William J. Francis | Jul. 8, 1952 |

What is claimed is:

1. A bio-inhibiting coating comprising gum resin 36.67 to 41.67%, paraffin wax 4.44 to 8.00%, ceresin wax, 2.38 to 4.55%, nickel linoleate 13.64 to 20.00%. nickel 32.46 to 37.87% and inert pigment 0 to 5.41%.

2. A bio-inhibiting coating consisting of gum resin 41.67%, paraffin wax 4.44%; ceresin wax 2.38%, nickel linoleate 13.64%, nickel 32.46%, and inert pigment 5.41%.

3. A bio-inhibiting coating comprising gum resin 36.67 to 41.67, waxes 6.82 to 12.55%, nickel 32.46 to 37.87%, an inert pigment 0 to 5.41% and 13.64 to 24.0% of nickel linoleate.
